(19) United States
(12) Patent Application Publication
(10) Pub. No.: US 2012/0002774 A1
(43) Pub. Date: Jan. 5, 2012

(54) METHOD FOR DETERMINING INTENSITY OF GAMMA RADIATION EMISSION OF A RADIOELEMENT

(75) Inventor: Pierre LECONTE, Aix En Provence (FR)

(73) Assignee: COMMISSARIAT A L'ENERGIE ATOMIQUE ET AUX ENERGIES ALTERNATIVES, PARIS (FR)

(21) Appl. No.: 13/154,319

(22) Filed: Jun. 6, 2011

(30) Foreign Application Priority Data
Jun. 7, 2010 (FR) 10 54453

(51) Int. Cl. G21G 1/10

(52) U.S. Cl. 376/157

(57) ABSTRACT

A method for determining the intensity I(Ech₁) of gamma radiation of a radioelement from the known intensity I(Ech₂) of gamma radiation of a standard radioelement, characterised in that it includes a step for calculating the intensity I(Ech₁) as:

$$I ( {Ech}_{1} ) = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2}}{Δ {ρ}_{1}} \frac{{W}_{A , 1}}{{W}_{A , 2}} ) I ( {Ech}_{2} )$$

where S(Ech₁) is the net area of the gamma radiation of the radioelement, S(Ech₂) is the net area of the gamma radiation of the standard radioelement, R1 and R2 are respectively a total absorption efficiency of the radiation detector used for measuring S(Ech₁) and of the radiation detector used for measuring S(Ech₂), Δρ₁ and Δρ₂ are measurements of reactivity variation of a nuclear reactor measured by the oscillation technique, and relating respectively to the radioelement and the standard radioelement, W_{A,1} and W_{A,2} are respectively the neutron importance of the radioelement and the neutron importance of the standard radioelement, and C_{d1} and C_{d2} are respectively a radioactive decay correction datum of the sample and a radioactivity decay correction datum of the standard sample.

### CROSS REFERENCE TO RELATED APPLICATIONS OR PRIORITY CLAIM

This application claims priority of French Patent Application No. 10 54453, filed Jun. 7, 2010.

### TECHNICAL FIELD AND PRIOR ART

The invention relates to a method for determining intensity of gamma (γ) radiation emission of a radioelement.

The intensities of gamma radiation emission of radioelements are data the knowledge of which is important in several fields of reactor physics. These are data used, for example, in non-destructive measurements (gamma spectrometry) or as inputs for the simulation codes used for determining photonic heating.

A first method for determining the intensity of gamma emissions emitted as a result of β⁻ decay consists in combining relative intensity measurements obtained with an excellent accuracy (around 1%) by high resolution spectrometry, for example thanks to a germanium detector, with β⁻branching ratio data, which are, on the other hand, less well controlled. For that reason, the gamma emission data obtained by this first method often have an uncertainty higher than 10%. This is a real drawback.

A more recent known method enables determining β⁻ branching ratios to be dispensed with. By measuring the decay rate by 4πβ−γ coincidence systems and the emission intensities by gamma spectrometry, significant improvements have been made achieving uncertainties better than 1% for some radionuclides. The accuracy obtained on determining the intensities of gamma emission and, in particular, on normalising these data, is however highly related to the radiological purity of the radionuclide studied, which also conditions the uncertainty on the decay rate. Thus, in view of the time required for preparing samples, this method turns out to be delicate to be implemented for radionuclides having a short lifetime, that is in the order of a few minutes to a few hours. This also is a real drawback.

The invention does not have the above mentioned drawbacks.

### DESCRIPTION OF THE INVENTION

Indeed, the invention relates to a method for measuring intensity of gamma radiation of a radioelement, characterised in that it includes:

a step for irradiating a sample of the radioelement and a sample of standard radioelement located in a nuclear reactor,

a step for removing the sample of the radioelement and the sample of standard radioelement from the nuclear reactor,

a step for determining a net area S(Ech₁) datum of gamma radiation of the sample of the radioelement by a first measuring channel,

a step for determining a net area S(Ech₂) datum of gamma radiation of the sample of standard radioelement by a second measuring channel identical to the first measuring channel,

a step for measuring a first reactivity variation Δρ₁ of the nuclear reactor by the technique of oscillation, between a first position of the sample of the radioelement where the sample of the radioelement is out of the nuclear reactor set to a given power and a second position of the sample of the radioelement where the sample of the radioelement is in the nuclear reactor set to said given power,

a step for measuring a second reactivity variation Δρ₂ of the nuclear reactor by the technique of oscillation between a first position of the sample of standard radioelement where the sample of standard radioelement is out of the nuclear reactor set to a given power and a second position of the sample of standard radioelement where the sample of standard radioelement is in the nuclear reactor set to said given power, and

a step for calculating the gamma intensity of the radioelement using the equation:

$$I ( {Ech}_{1} ) = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2}}{Δ {ρ}_{1}} \frac{{W}_{A , 1}}{{W}_{A , 2}} ) I ( {Ech}_{2} )$$

where R₁ and R₂ are respectively the total absorption efficiency of a detector of the first measuring channel at the energy of the sample of the radioelement and the total absorption efficiency of a detector of the second measuring channel at the energy of the sample of the standard radioelement,

W_{A,1}, and W_{A,2}, are respectively the neutron importance of the radioelement and the neutron importance of the standard radioelement,

C_{d1} and C_{d2} are respectively a radioactive decay correction datum of the sample of the radioelement and a radioactive decay correction datum of the sample of standard radioelement, and

I(Ech₂) is the gamma radiation intensity of the standard radioelement.

In one particular embodiment of the invention, the step for measuring a first reactivity variation Δρ₁ of the nuclear reactor is carried out by at least one position variation measurement of a control rod of the nuclear reactor between:

a) a first position of the control rod for which the sample of the radioelement is located outside the nuclear reactor set to a given power, and

b) a second position of the control rod for which the sample of the radioelement is located inside the nuclear reactor and the nuclear reactor is set, due to the second position of the control rod, to said given power.

Similarly, the step for measuring a second reactivity variation Δρ₂ of the nuclear reactor is carried out by at least one position variation measurement of the control rod of the nuclear reactor between:

a) a first position of the control rod for which the sample of standard radioelement is located outside the nuclear reactor set to a given power, and

b) a second position of the control rod for which the sample of standard radioelement is located inside the nuclear reactor and the nuclear reactor is set, due to the second position of the control rod, to said given power.

According to a further characteristic of the invention, the method further includes at least one step for measuring a reactivity variation Δρₑ of the nuclear reactor by the method of oscillation between a first position of an empty sample where the empty sample is out of the nuclear reactor set to a given power and a second position of the empty sample where the empty sample is in the nuclear reactor set to said given power, the reactivity measurement Δρₑ being subtracted from the respective reactivity measurements Δρ₁ and Δρ₂ so that a corrected gamma intensity I(Ech₁)_{C} of the radioelement is given by the equation:

$${I ( {Ech}_{1} )}_{C} = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2} - Δ {ρ}_{e}}{Δ {ρ}_{1} - Δ {ρ}_{e}} \frac{{W}_{A , 1}}{{W}_{A , 2}} ) I ( {Ech}_{2} ) .$$

### BRIEF DESCRIPTION OF THE FIGURES

Further characteristics and advantages of the invention will become clearer upon reading a preferred embodiment made in reference to the appended figures, in which:

FIG. 1 represents a block diagram of the method for determining intensity of gamma radiation of the invention;

FIG. 2 represents a block diagram of a series of particular steps of the method of the invention represented in FIG. 1;

FIG. 3 represents a first device configuration which assists in implementing the method of the invention;

FIG. 4 represents a second device configuration which assists in implementing the method of the invention;

FIGS. 5A and 5B represent, respectively, a third and a fourth device configuration which assist in implementing the series of particular steps represented in FIG. 2.

Throughout the figures, the same references denote the same elements.

### DETAILED DESCRIPTION OF A PREFERRED EMBODIMENT OF THE INVENTION

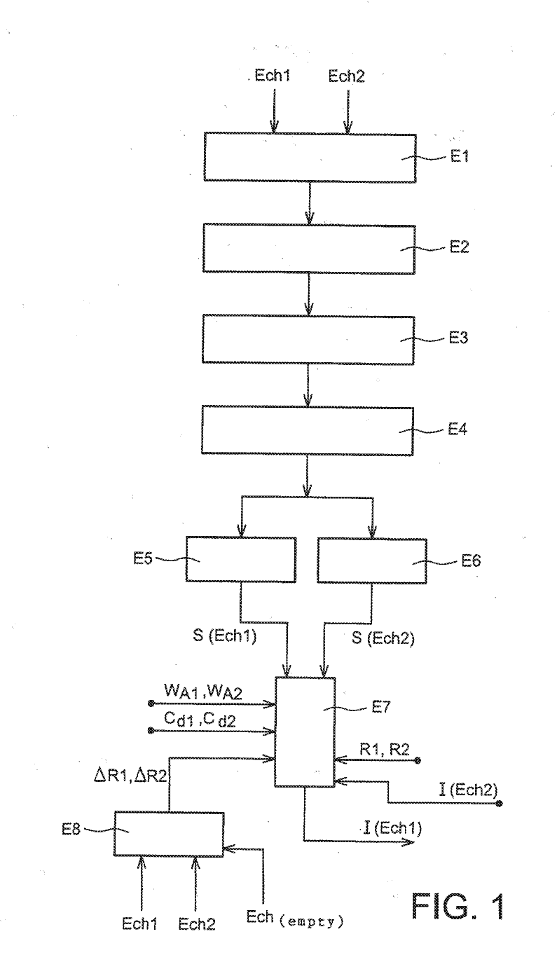

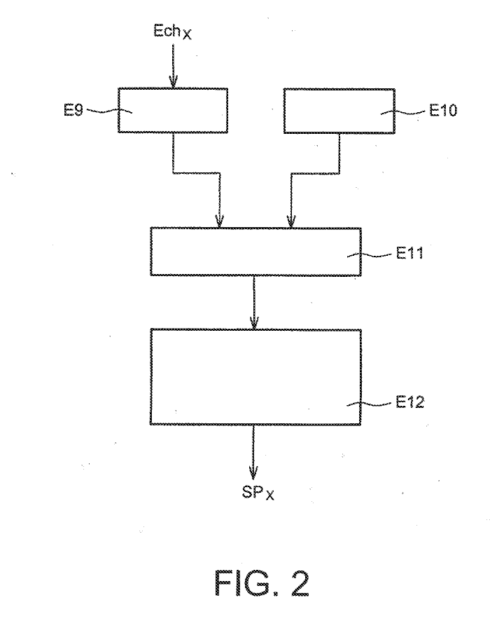

FIG. 1 represents a block diagram of the method for determining intensity of gamma radiation of the invention and FIG. 2 represents a block diagram of a series of particular steps of the method of the invention represented in FIG. 1.

The method of the invention includes (cf. FIG. 1) a step E₁ for mounting, in an oscillation rod, the sample Ech₁, the gamma emission intensity I(Ech₁) of which is to be determined and a standard sample Ech₂ the gamma emission intensity I(Ech₂) of which is known, a step E₂ for mounting the oscillation rod provided with samples Ech₁ and Ech₂ in a nuclear reactor, a step E₃ for irradiating samples Ech₁ and Ech₂ placed in the nuclear reactor, a step E₄ for removing the irradiated samples from the nuclear reactor, a step E₅ for measuring net area of gamma radiation of the irradiated sample (measurement of the area of gamma line) and for shaping the measurement of net area to obtain a net area S(Ech₁) datum, a step E₆ for measuring a net area of the irradiated standard sample (measurement of the area of the gamma line) and for shaping the net area measurement obtained to form a net area S(Ech₂) datum, the measurements of net area of gamma radiation of the respective irradiated samples Ech₁ and Ech₂ being able to be carried out using a single measuring channel (in which case the measurements are consecutively carried out), or two measuring channels identical to one another (in which case the measurements can be simultaneously carried out) and a step E₇ for calculating the gamma emission intensity I(Ech₁) of the sample Ech₁ from:

net area S(Ech₁) and S(Ech₂) data,

total absorption efficiencies R1 and R2 of the detector of the measuring channel for the gamma radiation energies of the respective samples Ech₁ and Ech₂ (total absorption efficiencies recorded beforehand, obtained using reference radioactive sources having the same energies as the respective samples Ech₁ and Ech₂),

absorption neutron importance W_{A,1} and W_{A,2} data relating to the respective samples Ech₁ and Ech₂,

a first reactivity variation Δρ₁ of the nuclear reactor between a first position where the sample of the radioelement is out of the nuclear reactor set to a given power and a second position where the sample of the radioelement is in the nuclear reactor set to said given power,

a second reactivity variation Δρ₂ of the nuclear reactor between a first position where the sample of standard radioelement is out of the nuclear reactor set to a given power and a second position where the sample of standard radioelement is in the nuclear reactor set to said given power,

radioactive decay correction C_{d1} and C_{d2} data relating to the respective samples Ech₁ and Ech₂, and

the known gamma emission intensity I(Ech₂) of the standard radioelement.

It follows:

$$I ( {Ech}_{1} ) = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2}}{Δ {ρ}_{1}} \frac{{W}_{A , 1}}{{W}_{A , 2}} ) I ( {Ech}_{2} ) . \qquad ( 1 )$$

Obtaining W_{A,1}, W_{A,2}, C_{d1}, C_{d2}, R₁ and R₂ data, will now be set out.

The absorption neutron importance W_{A,X} datum of a radioactive sample X is, in a known manner per se, the importance function, defined as the average value of the adjoint flux Φ*, weighted by the capture rate. It follows:

$${W}_{A , X} = \frac{{\int }_{sample X volume}^{ } Σ ( E ) φ ( E , \vec{r} ) φ * ( E , \vec{r} ) d E d \vec{r}}{{\int }_{sample X volume}^{ } Σ ( E ) φ ( E , \vec{r} ) d E d \vec{r}} \qquad ( 2 )$$

where, by definition, the quantity

$${\int }_{sample X volume}^{ } Σ ( E ) φ ( E , \vec{r} ) d E d \vec{r}$$

represents the capture rate of the sample X and Φ* is the adjoint flux, the magnitude E being the neutron energy. It will also be remembered that the adjoint flux is the solution of the Boltzmann adjoint equation which describes the neutron transport in a nuclear reactor.

In a thermal neutron spectrum obtained by placing a neutron moderator material about the sample, it is known to those skilled in the art that the absorption importance function W_{A,X} is substantially independent from the isotope contained in sample X.

In a known manner per se, the radioactive decay correction C_{dX} datum of a sample X is given by the formula:

$${C}_{d} = \frac{( 1 - {e}^{- λ {t}_{i}} ) {e}^{- λ {t}_{o}} ( 1 - {e}^{- λ {t}_{m}} )}{λ} , \qquad ( 3 )$$

wherein:

λ is the radioactive constant,

tᵢ, is the radiation duration of the sample,

t₀ is the time of radioactive decay between the end of the irradiation and the beginning of the measurement,

tₘ is the duration of the gamma radiation measurement.

The absorption efficiency variation data are deduced from reactivity measurements carried out by the oscillation technique. Several types of measurements which use the oscillation technique can be implemented within the scope of the invention. It can be, for example:

“kinetic” measurements where the reactivity variation is deduced from neutron flux variations observed between the state (1) where the sample is out of the reactor and the state (2) where the sample is in the reactor, without stabilising the power by a control means;

“static” measurements where the reactivity variation is deduced from the position of a control rod which enables the power to be maintained constant between state (1) and state (2).

FIG. 2 illustrates the preferred embodiment of the invention wherein the reactivity variation Δρ measurement of the reactor associated to a radioelement X is deduced from the position variation δP_{X} of a control rod of the nuclear reactor.

The process for obtaining the position variation δP_{X} datum includes a step E9 for mounting a sample Ech_{X} in an oscillation rod, a step E10 for operating a nuclear reactor at the critical state (i.e. operating the nuclear reactor so that it delivers a given stable power), a step E11 for oscillating the rod provided with the sample Ech_{X} in the nuclear reactor at the critical state (i.e. a succession of introduction/extraction of the rod in the reactor), during which measurements of the position of the control rod are carried out and a step E12 for calculating the position variation δP_{X} from the position measurements of the control rod.

The nuclear reactor is provided, in a known manner per se, with a control rod likely to be moved to adjust the power it delivers. As soon as the critical state of the reactor is obtained, the position of the control rod which is associated to this critical state is measured. During oscillating the oscillation rod, each time the rod is present in the reactor, an instability of the reactor occurs resulting in the power delivered by the reactor being changed. A feedback of the position of the control rod is then implemented to cancel instability which occurs in the reactor (back to the initial power value). The position of the control rod which cancels the instability is then measured. The position variation of the control bar is then calculated. There is a ratio, of the control rod variation to the reactivity variation, which is calculated.

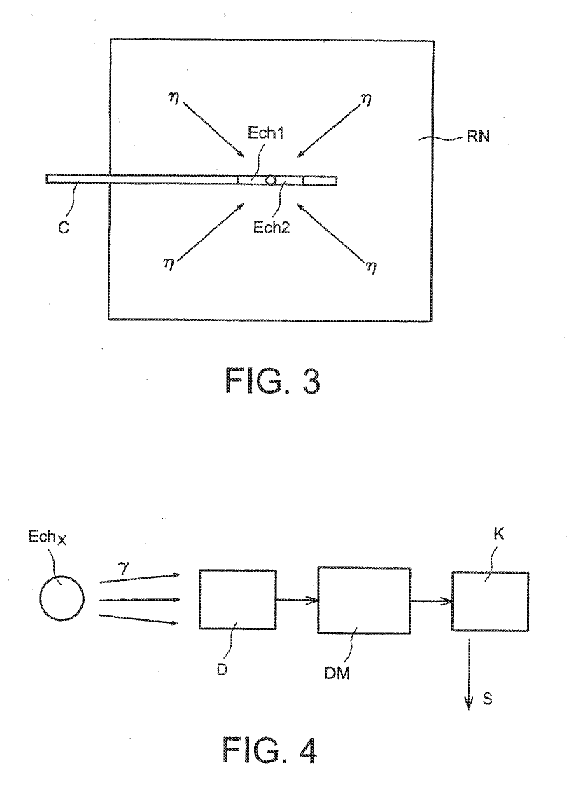

FIG. 3 represents a first device configuration which assists in implementing the method of the invention. The device represented in FIG. 3 implements step E3 for irradiating samples Ech₁ and Ech₂. Samples Ech₁ and Ech₂ placed in a nuclear reactor RN are mounted in an oscillation rod C and bombarded with neutrons n. The oscillation rod is here used as mere sample holder and is not subjected to any oscillation movement.

Samples Ech₁ and Ech₂ are placed in two symmetrical positions of the reactor core in order to be irradiated in the same neutron flux. Practically, samples Ech₁ and Ech₂ are placed between aluminium round billets (not shown in the figure) which ensure a separation distance therebetween, for example of at least 10 cm, in order for them not to be mutually disturbed. The oscillation rod is fastened to a translation mechanical system which is to position the two samples symmetrically with respect to the median plan of the nuclear reactor, in the central channel, thus ensuring a high thermalization to the neutrons. Once the samples are positioned in the reactor, the operator controls the reactor divergence by means of a control device. The control device is, for example, made up of four control rods of hafnium, a material which is very absorbent to neutrons, which is gradually extracted from the reactor by means of a vertical translation device. The reactor is stabilised at a given power, in the order of a few tens of Watts (typically between 20 and 80 W). The reactor is maintained at the critical state during the time required for the neutron activation of the materials making up both samples. Once the irradiation time is reached, the reactor is shut down by means of a control device.

FIG. 4 represents a second device configuration which assists in implemented the method of the invention. The device represented in FIG. 4 implements step E5 for measuring net areas. The device includes a gamma radiation detector D, an electronic measuring device DM and a calculator K. The detector D is, for example, a detector of the Hyper-Pur Germanium type. The electronic measuring device DM provides for collecting and storing signals delivered by the detector D. The calculator K processes the signals delivered by the electronic measuring device DM and, via a specific software known per se, delivers a net area S datum for each studied line of gamma radiation.

Each sample Ech_{X} (X=1, 2) is individually measured on the measuring channel made up of elements D, DM and K, for a duration ranging from a few minutes to a few hours. The uncertainty generally reached on the activity measurement of the radionuclide created by activation is 0.5%, or even less. For this, for example, at least forty thousand counts are recorded in the net area of the peak by extending the measuring duration as long as necessary. Generally the experiment is repeated, for example at least three times, to check for the consistency of the results.

In the embodiment of the invention described above, both samples Ech₁ and Ech₂ are simultaneously irradiated in symmetrical positions with respect to the inner volume of the reactor in order for the samples to see the same neutron flux. According to another embodiment of the invention, irradiating each sample is made separately, the samples being consecutively placed into the median plan of the reactor.

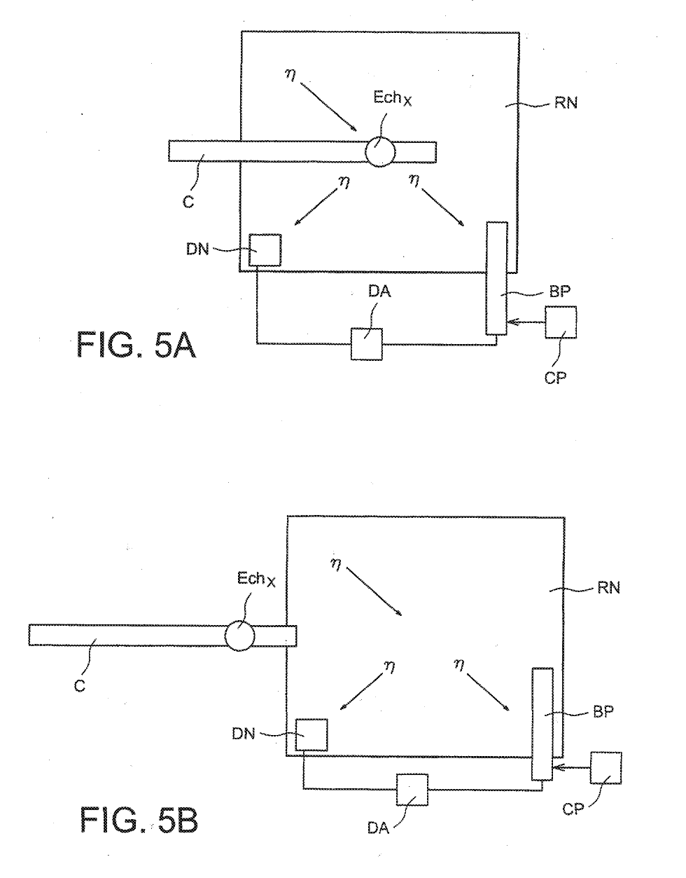

FIGS. 5A and 5B represent respectively a third and a fourth device configuration which assist in implementing the series of particular steps represented in FIG. 2.

More particularly, FIGS. 5A and 5B represent both end positions of the oscillation rod during step E11 previously mentioned. FIG. 5A represents the oscillation rod inside the nuclear reactor and FIG. 5B represents the oscillation rod outside the reactor. In both cases, the device includes the nuclear reactor RN, the oscillation rod C provided with one sample Ech_{X} (X=1, 2), a neutron detector DN, for example a boron burial chamber, a movable control rod BP, a feedback device DA and a position measuring sensor CP able to measure the position of the control rod BP. The control rod BP is made up of a material absorbing neutrons and its more or less significant insertion into the reactor RN results in a neutron density variation.

The oscillation rod C which contains sample Ech_{X} is moved by means of a mechanical system (not represented in the figures) between the position outside the nuclear reactor RN (cf. FIG. 5B) and the position inside the nuclear reactor (cf. FIG. 5A).

Before the sample is introduced into the nuclear reactor, an operator controls divergence thereof by means of a control system known per se (not represented in the figure). When the reactor is at the critical state, the feedback device DA controls the control rod BP to finely adjust the criticality (obtaining a stable value of the power emitted). The position sensor CP then measures the position of the control rod BP, the sample being still located outside the nuclear reactor. The sample is then introduced into the nuclear reactor RN. It is assumed that, during the residence of the sample in the reactor, the isotope _{Z}^{A}X only interacts by radiating capture. It can then be shown that between the sample position outside the nuclear reactor and the sample position inside the nuclear reactor, the neutron density n(r) at a point r of the reactor volume undergoes a variation that can be considered as the sum of two effects:
a global disturbance, related to the variation of the capture component δΣ by a transfer function H independent from the position, and

a local disturbance, proportional to the variation of the capture cross-section δΣ by a function a(r) rapidly decreasing as a function of the distance from the disturbed area.

The fundamental relationship that reflects both effects and on which relies the measuring method of the invention is the following:

$$\frac{δ n ( r )}{n} = H δ k + a ( r ) δ ( Σ ) \qquad ( 4 )$$

where δn(r)/n is the relative variation of neutron density at point r and δk is, by definition, the variation of the effective multiplication factor k of the reactor between both positions “sample inside the reactor” and “sample outside the reactor”.

The neutron detector DN is located sufficiently far from the sample to allow an accurate measurement of the variation of neutron density which is caused due to the introduction of the sample into the nuclear reactor. The information relating to the neutron density variation which is detected by the detector DN is then transmitted, through the feedback device DA, to the control rod BP. Under the effect of the signal delivered by the detector DN, the feedback device DA then compensates for the disturbance caused by the presence of the sample in the reactor. This compensation results in moving the criticality of the reactor back into its initial state, that is the state thereof before the sample has been introduced (back to the value of constant neutron flux). The sensor CP for measuring the position of the control rod BP then measures the position occupied by the rod BP in the critical state restored. The position variation δP of the control rod is calculated. Then, it is possible to create a ratio χ, whether linear or not, between the position variation δP and the reactivity variation δk/k, previously designated Δρ, this variation induces. There follows:

δP=χΔρ (5)

By applying the exact perturbation theory to express the reactivity variation Δρ, the position variation δP is then related to the capture rate T_{C} on the isotope _{Z}^{A}X making up the sample, by using to the absorption neutron importance function W_{A}, that is:

δP=αW_{A}T_{C} (6)

where α is a proportionality constant which does not depend on the isotope _{Z}^{A}X chosen, provided that the reactivity variation δk/k be in the order of ten per one hundred thousand (10⁻⁴). This condition on the reactivity variation implies that the sample is of a small size, for example 10 cm³, and that it contains a material amount in the order of a few milligrams to a few grams.

W_{A} is the importance function, defined as previously mentioned, namely:

$${W}_{A} = \frac{{\int }_{samplevolume}^{ } Σ ( E ) φ ( E , \vec{r} ) φ * ( E , \vec{r} ) d E d \vec{r}}{{\int }_{samplevolume}^{ } Σ ( E ) φ ( E , \vec{r} ) d E d \vec{r}}$$

In a thermal neutron spectrum, obtained by placing a neutron moderator material about the sample, it is demonstrated that this term W_{A} is substantially independent from the isotope contained in the sample.

The sample is then removed from the reactor RN and the feedback device places the reactor RN in the initial critical state again.

To reduce the measurement uncertainties, for example, five to ten oscillation cycles (one oscillation cycle consisting in inserting and extracting the sample in and from the nuclear reactor) are consecutively repeated with steps corresponding to two “out of reactor” and “in the reactor” states in the order of one minute, which measurements are repeated, for example, at least five times in the course of an experimental program in order to test the influence of loading/unloading the sample into and from the oscillation rod.

Preferentially, these different position measurements are carried out, consecutively and under the same conditions, not only for the sample (Ech₁) studied and for the standard sample (Ech₂), but also for an empty radioelement-free sample, having the same geometry as the studied and standard samples (same cladding, same dimensions but containing no isotope). The reactivity variation measurements obtained for the empty sample are then subtracted from the measurements obtained for the sample studied and the standard sample. It is then advantageously possible to correct the experimental errors due to the structure that contains the isotopes. The corrected intensity is then written as:

$${I ( {Ech}_{1} )}_{C} = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2} - Δ {ρ}_{e}}{Δ {ρ}_{1} - Δ {ρ}_{e}} \frac{{W}_{A , 1}}{{W}_{A , 2}} ) I ( {Ech}_{2} ) .$$

1. A method for determining the intensity of gamma radiation of a radioelement, characterised in that it includes:
a step (E3) for irradiating a sample of the radioelement and a sample of standard radioelement located in a nuclear reactor,
a step (E4) for removing the sample of radioelement and the sample of standard radioelement from the nuclear reactor,
a step (E5) for determining a net area S(Ech₁) datum of gamma radiation of the sample of the radioelement by a first measuring channel,
a step (E6) for determining a net area S(Ech₂) datum of gamma radiation of the sample of standard radioelement by a second measuring channel identical to the first measuring channel,
a step for measuring (E8) a first reactivity variation Δρ₁ of the nuclear reactor by the technique of oscillation between a first position of the sample of the radioelement where the sample of the radioelement is out of the nuclear reactor set to a given power and a second position of the sample of the radioelement where the sample of the radioelement is in the nuclear reactor set to said given power,
a step for measuring (E8) a second reactivity variation Δρ₂ of the nuclear reactor by the technique of oscillation between a first position of the sample of standard radioelement where the sample of standard radioelement is out of the nuclear reactor set to a given power and a second position of the sample of standard radioelement where the sample of standard radioelement is in the nuclear reactor set to the given power,
a step for calculating (E7) the gamma intensity of the radioelement using the equation:
$$I ( {Ech}_{1} ) = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2}}{Δ {ρ}_{1}} \frac{{W}_{A , 1}}{{W}_{A , 2}} ) I ( {Ech}_{2} )$$
where
R₁ and R₂ are respectively the total absorption efficiency of the detector of the first measuring channel at the energy of the sample of the radioelement and the total absorption efficiency of the detector of the second measuring channel at the energy of the sample of standard radioelement, W_{A,1} and W_{A,2} are respectively, the neutron importance of the radioelement and the neutron importance of the standard radioelement,
C_{d1} and C_{d2} are respectively a radioactive decay correction datum of the sample of the radioelement and a radioactive decay correction datum of the sample of standard radioelement, and
I(Ech₂) is the gamma radiation intensity of the standard radioelement.

2. The method according to claim 1, wherein the step for measuring (E8) a first reactivity variation Δρ₁ of the nuclear reactor is carried out by at least one position variation measurement of a control rod (BP) of the nuclear reactor between:
a) a first position of the control rod for which the sample of the radioelement is located outside the nuclear reactor and the nuclear reactor is set to a given power, and
b) a second position of the control rod for which the sample of the radioelement is located inside the nuclear reactor and the nuclear reactor is set, due to the second position of the control rod, to said given power, and
the step for measuring a second reactivity variation Δρ₂ of the nuclear reactor is carried out by at least one position variation measurement of the control rod of the nuclear reactor between:
a) a first position of the control rod for which the sample of standard radioelement is located outside the nuclear reactor and the nuclear reactor is set to a given power, and
b) a second position of the control rod for which the sample of standard radioelement is located inside the nuclear reactor and the nuclear reactor is set, due to the second position of the control rod, to said given power.

3. The method according to claim 1, which further includes at least one step for measuring a reactivity variation Δρₑ of the nuclear reactor by the method of oscillation between a first position of an empty sample where the empty sample is out of the nuclear reactor set to a given power and a second position of the empty sample where the empty sample is in the nuclear reactor set to said given power, the reactivity measurement Δρₑ being subtracted from the respective reactivity measurements Δρ₁ and Δρ₂ so that a corrected gamma intensity I(Ech₁)_{C} of the radioelement is given by the equation:
$${I ( {Ech}_{1} )}_{C} = ( \frac{S ( {Ech}_{1} )}{S ( {Ech}_{2} )} \frac{{R}_{2}}{{R}_{1}} \frac{{C}_{d 2}}{{C}_{d 1}} \frac{Δ {ρ}_{2} - Δ {ρ}_{e}}{Δ {ρ}_{1} - Δ {ρ}_{e}} \frac{{W}_{A , 1}}{{W}_{A , 2}} ) I ( {Ech}_{2} ) .$$

4. The method according to claim 1, wherein the total absorption efficiencies R1 and R2 are measured beforehand using reference radioactive sources.

5. The method according to claim 1, wherein the second measuring channel and the first measuring channel are one and single measuring channel and in that the step for determining the net area S(Ech₁) datum is carried out simultaneously with the step for determining the net area S(Ech₂) datum.
